(19) United States
(12) Patent Application Publication
(10) Pub. No.: US 2010/0270189 A1
(43) Pub. Date: Oct. 28, 2010

(54) PROTECTIVE COVERING WITH A CUSTOMIZABLE IMAGE FOR AN ELECTRONIC DEVICE

(75) Inventors: Robert G. Pedersen, II, Salt Lake City, UT (US); Brian S. Packer, Highland, UT (US); Jonathan B. Benson, Bountiful, UT (US)

Correspondence Address: Workman Nydegger;1000 Eagle Gate Tower, 60 East South Temple, Salt Lake City, UT, 84111, US

(73) Assignee: ZAGG, INC., Salt Lake City, UT (US)

(21) Appl. No.: 12/721,396

(22) Filed: Mar. 10, 2010

Related U.S. Application Data
(63) Continuation-in-part of application No. 11/681,665, filed on Mar. 2, 2007.
(60) Provisional application No. 60/778,339, filed on Mar. 2, 2006.

(51) Int. Cl. B65D 85/00; B32B 38/10; B28B 19/00

(52) U.S. Cl. 206/320; 156/253; 156/390

(57) ABSTRACT

A customizable protective cover for electronic devices. A film is prepared which includes a first layer and an adhesive layer. An image is printed on a first side of the first layer such that the image is covered by the adhesive layer and visible through a second side of the first layer when applied to a device. The film provides a protective layer for both the image and the electronic device. The film may include multiple pieces, including portions which include the vinyl layer and other portions where the film comprises solely a transparent covering.

### CROSS-REFERENCE TO RELATED APPLICATIONS

This application is a continuation-in-part of U.S. Utility application Ser. No. 11/681,665 entitled PROTECTIVE COVERING FOR AN ELECTRONIC DEVICE filed Mar. 2, 2007, which claims the benefit of U.S. Provisional Application Ser. No. 60/778,339 entitled PROTECTIVE COVERING FOR AN ELECTRONIC DEVICE and filed Mar. 2, 2006, which applications are incorporated by reference in their entirety.

### BACKGROUND OF THE INVENTION

1. The Field of the Invention

The present invention relates to protective coverings. More particularly, embodiments of the invention relate to systems and methods for covering or shielding electronic devices with thin films including plastic films which include images, including customized images.

2. The Relevant Technology

Advances in many technology areas have resulted in a proliferation of electronic devices. Many of these devices are portable in nature. Cellular telephones, digital music (e.g., MP3) players, personal digital assistants, satellite radios, laptop computers and portable video/picture players, are examples of electronic devices in use today.

Many of these devices have multiple functions. Some cell phones, for example, are also capable of storing and playing digital music. Some digital music players also have the ability to store digital pictures and video. Many devices also provide their users with various programs such as calendaring applications, email applications, and word processing applications. The increasing versatility and functionality of electronic devices has only led to further reliance on these devices.

The size, versatility, and portability of these devices provides significant advantages. At the same time, and because these devices are electronic in nature, there are some inherent weaknesses that are difficult to overcome. For example, many of these devices have screens or casings that can be scratched or damaged. Often, this type of damage can occur during normal use of the device. Few people enjoy looking at a scratched or damaged screen or casing for many reasons. First of all, a scratched screen or casing is not pleasant to view. In addition, the scratch or damage may actually interfere with the ability of a user to see the displayed images or text. In general, a scratched or damaged screen and/or casing diminishes the use and value of the device to the user in part because users often want their devices to retain their original look and feel as long as possible.

Because these devices are used frequently, it is likely that they will be dropped, banged against other objects, and receive other types of abuse, whether deliberate or accidental. In fact, most of the abuse that these devices receive is unintentional. Nonetheless, the damage these devices receive over time can diminish their value and reduce their usability or impair their appearance. In particular, a scratched screen is unsightly, may interfere with the user's visual experience (pictures and videos may be hard to watch, text may be hard to read, etc.).

When a device is initially purchased, the screen is often covered by a piece of plastic that has a static adherence to the device. This covering is only meant to provide protection during shipping and is supposed to be removed. It is easily removed and typically includes a tab specifically for removal.

There are some existing screen coverings or protective shields in use today. However, the protection afforded by these screens is temporary and the protection provided is limited for several reasons. For example, conventional screen coverings wear out rather quickly and need to be replaced often. This is expected and these types of coverings are often sold in groups. Some of these coverings do not adhere to the screen, but slip into place and are held loosely over the screen.

Conventional screen coverings themselves are subject to scratches and the like as well. One significant drawback of some conventional coverings is that they begin to separate from the device at the corners and become deformed. As the edges begin to fray or become separated from the device, the appearance bothers the user and the cover is usually removed. In addition, conventional screen coverings are unable to protect the entire device and are typically limited to the screen of an electronic device.

### BRIEF SUMMARY OF THE INVENTION

These and other limitations are overcome by embodiments of the invention which relate to systems and methods for protecting devices with customizable coverings. More particularly, embodiments of the invention relate to body covers including plastic films that have customizable images embedded (e.g., printed or otherwise formed) therein or thereon which are capable of adhering to surfaces of a device for which protection is desired. One embodiment of a film for a device includes a printed layer which is covered by a resistant upper layer which is transparent and clear so that the printed layer may be seen below the upper layer. Further, the film may adhere naturally to surfaces of a devices, or adhere using an adhesive. The adhesive may adhere to the device or may include pressure bonding and/or temperature bonding in some instances. The film is specifically configured to cover a user's device, such that the film may be specifically shaped so as to correspond to the user's device. This may include incorporating cutout portions in the film and/or using a variety of different films, including those with images therein and additional films which are clear. As described more fully below, by combining a variety of films, including those with graphics and others which are clear, embodiments are capable of offering a user a customizable cover for their electronic device, while simultaneously protecting the device and the image from damage. In other embodiments, the image can be printed on a cover after which the adhesive is applied.

Embodiments of the invention further contemplate a solution that is used during the application process to ensure that the film(s) properly adheres to the device. The solution can be applied to the adhesive on the side of the film adhered to the electronic device in order to allow the film to be properly positioned on the device prior to full adhesion of the film to the device. Additionally, the solution may also make it easier to remove air bubbles from underneath the film, although as described more fully below, embodiments of the invention may include using an adhesive layer which is specifically designed to capture any air bubbles that are formed between the device and the film so that the bubbles do not affect the overall performance and durability of the film.

Furthermore, in another embodiment, the film may be designed to be reusable, so that the film(s) may be removed and reapplied to the electronic device a number of times, rather than being permanently affixed to the device. As described more fully below, the specific adhesion properties of the film(s) depend on the adhesive used to affix the film to the device.

A body cover is one embodiment of a film that is used to protect more than a screen of a device, while offering the user the ability to customize their device by adding an image to the film. In addition to adding aesthetic value to the device, the body cover protects other surfaces and/or aspects of the device. A body cover ensures that the original condition of the device is protected. As described below, the body cover is typically configured to lay flat against the surface of the device including surfaces such as curves, sloping surfaces, edges, discontinuities and the like or combinations thereof. The film or portions of the film may be cut to accommodate variations in the surfaces of the device.

In one embodiment, a body cover can include one file or multiple films, including films which have graphics or images disposed therein, and other films which are clear and which do not have graphics. For example, a first film which includes a graphic may cover a first surface of a device such as the front surface. The first film may include a cutout portion so that a screen or user interface is not covered by the graphic, allowing the user to interact and view the user interface. A second film of the body cover which is transparent may be applied to the screen and/or user interface where the cutout portion of the first film is located so that a user may still see and use the user interface and/or screen. Additional films may also be provided in order to protect additional surfaces of the device such as the back and/or the sides. Further, the first or second films may be configured (such as by cutting or with slits/cuts) that enable the film to lay flat against the surface of the device by accounting for surfaces that are not flat (e.g., corners, sloping surfaces, edges including rounded edges, lips, and the like). Also, the first or second film may be designed to allow for ports or other aspects of the device that may be used for other purposes such as communication with another device.

A body cover or a single film may also have cutout areas that ensure that the film does not impede some functionality of the device and that does not reduce the effectiveness of the body cover. For example, a user interface on a device that is capable of movement (e.g., rotation, depression) may correspond to a cut out area and/or the use of additional films. If the movable user interface were covered with a single film along with other surfaces of the device, then use of the user interface may be degraded and may cause the film to separate from the surface or make it difficult to use the user interface. At the same time, a body cover may also include a separate film for the user interface, thereby avoiding these problems while providing protection to the user interface or other aspect of the device and without interfering with operation of the user interface or other aspect of the device.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a perspective view of an exemplary electronic device which may be used in association with embodiments of the invention, the exemplary electronic device including a screen and a user interface;

FIG. 2 illustrates a variety of exemplary covers which may be fixed to an electronic device;

FIG. 3 illustrates a body cover according to an embodiment of the invention which illustrates the various layers of the body cover;

FIG. 4 a method of creating a customized body cover according to the invention;

FIG. 5 illustrate a portion of the applicant process for applying a body cover to an electronic device;

FIG. 6 illustrates a body cover for a device including a plurality of films; and

FIG. 7 illustrates a kit for covering a device including the body cover of the invention.

### DETAILED DESCRIPTION OF THE PREFERRED EMBODIMENTS

Embodiments of the invention relate to customizable protective coverings and more particularly, to thin film or plastic coverings or shields for electronic devices including portable electronic devices. Embodiments of the invention also relate to protective coverings for the screens of electronic devices. Other embodiments of the invention provide protection to other surfaces of the various devices that may include the screen or display of the device. Embodiments of the invention therefore relate to device protectors (also referred to herein as covers, shields, body covers or body shields) that may include more than one film in addition to films that protect screens. A customizable body cover may include one or more separate films that are configured to protect the outer surfaces of the device which includes an image or other graphic, while providing a transparent film which provides protection for other areas of the device, including the screen or any other user interface elements.

Because the surfaces of the bodies or the housings of electronic devices are not flat, but may have corners, sides, edges, bulges, protrusions, depressions, discontinuities, lips, shelves, etc., embodiments of the invention are configured such that the film does not bunch or wrinkle. As described more fully below, this can be achieved by selectively cutting the film, specific layers of the film, or by dividing the body covering into multiple pieces. For example, the film for a battery cover may be separate from other films of a body cover for other surfaces of the device. This ensures that the surface of the battery cover is protected without interfering with the operation of the device. In an alternative embodiment described more fully below, one layer of a multi-layered film, or a single layer film, may include a cutout portion in the layer of the film where the image is formed, while another layer of the film may not be cutout. One advantage of this configuration is that it is possible to form a film which covers an entire surface of a device, including the user interface and/or screen, while simultaneously covering a portion of the surface of the device with the image.

The films described herein can be customized for individual users with an image from, by way of example, an online collection, the user's own image, or the like. The film may include one or more plastic layers (e.g., urethane, vinyl, etc.) and one or more adhesive layers. In one example, the image is formed or printed on a urethane layer and an adhesive layer is then applied on top of the image. This example of a film includes two layers and the image is between the urethane layer and the adhesive layer. When such a film is applied to the device, both the image and the device are protected by the urethane layer. In another film the image can be printed on a plastic layer that is different from the plastic layer that provides protection to the image and/or the device. Of course, the adhesive layers may be covered with a backing that is removed prior to application of the films to devices.

When the films of a body cover are properly applied to various surfaces of a device, the films are preferably smooth and flat against the various surfaces of the device and are substantially free of air bubbles, which may become trapped between the film and the surface of the device. For example, if a flat and substantially rectangular film is applied to a corner of a device, the film will bunch and not lay flat on the surfaces of the device. In addition to being unsightly, bunching and/or air pockets may adversely cause the film to separate from the device and bother the user. Further, the film is susceptible to peeling away from the device surface wherever bunching occurs. Embodiments of the invention eliminate these problems.

Embodiments of the invention include films that are cut or formed so as to correspond with the specific configuration of the electronic device such that the surfaces of the device are substantially covered without bunching and substantially without creating air pockets. The cuts made to the various films included in a body cover for a device are configured to account for curved surfaces in addition to corners, edges, depressions, bulges, and the like or any combination thereof. In some embodiments, the film can wrap around edges or corners without bunching or creating air pockets or bubbles. The film may be cut, for example, if a particular edge of a device is not straight or is curved. Such a cut may be used when a portion of the surface can be viewed as a ramp in one embodiment. Alternatively, the film may be separated into multiple pieces that can be applied separately to the device.

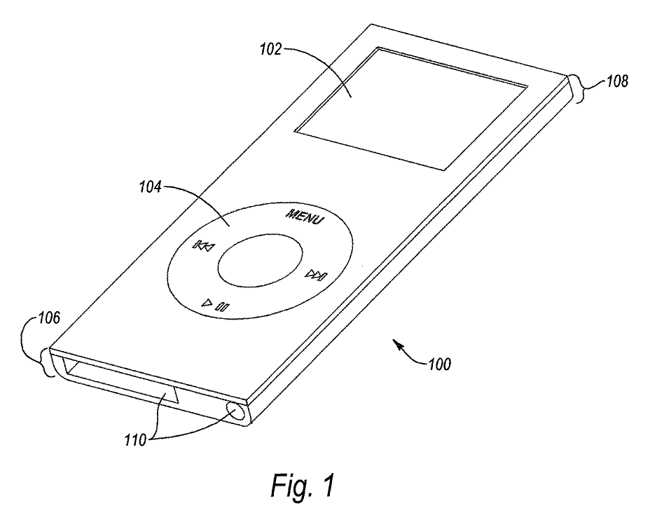

FIG. 1 illustrates an exemplary device and is intended to be representative of other devices. The device 100 represents, by way of example and not limitation, cellular telephones, digital music players, audio recorders, laptop computers, personal digital assistants, satellite radios, watches, GPS devices, bike computers, digital cameras, heart rate monitors, portable DVD players, dive computers, and the like or any combination thereof. Embodiments of the invention are further not limited to electrical devices, but can also protect other devices that may or may not have screens or displays.

The device 100 typically includes a screen 102, although some devices may not include a screen. Embodiments of the invention can protect a screenless device as well. In this example, the screen 102 may be flush with a top surface of the device 100 or may be inset with respect to the top surface of the device 100. The relative position of the screen with respect to the corresponding surface may have an impact on how the protective cover is prepared for application on the device 100. In general, embodiments of the invention can be adapted for devices that have surfaces with discontinuities (such as the boundaries between an inset screen and the corresponding surface of the device or between buttons and the corresponding surface of the device). Typically, the discontinuities are accounted for by forming cutout areas in the films of the body cover. This ensures that each film can lay flat against a portion of a surface and also ensures that the functionality of the device corresponding to the cutout area is not impaired. Further, a separate film may be used to protect the area of the device corresponding to the cut out area. The cutout portion may be used to protect the corresponding surface area. In one embodiment, the cutout film may be used on a cut out area.

By using multiple films in a body cover, protection and customization is achieved for each covered surface without interfering with operation of the device. For instance, using a separate film for a user interface that moves ensures that the film moves with the user interface without affecting the film applied to the other surfaces of the device. Similarly, using a separate transparent film for a display element of the device ensures that the user may easily view the display while still allowing the user to add customizable images to the remaining surfaces of the device.

The device 100 also includes surfaces or sides 106 and 108 and other sides not shown. The device also has a front side/surface and back side/surface. In this example, the side 106 has ports 110. The ports 110 enable the device 100 to connect to another device. For instance, the device 100 may be rechargeable and connects to an external power supply for recharging through one of the ports 110. Alternatively, the ports 110 or one of the ports may enable the device to exchange data with another device such as a host computer or to provide output to a user of the device (e.g., headphones). One of skill in the art can appreciate that the form factors for electronic devices can widely vary. With the benefit of the teachings contained herein, one of skill in the art can prepare and apply a protective cover to any electronic device.

The device 100 also includes a user interface 104. Often, the user interface 104 and the screen 102 work together to enable a user to use the device. In the case of a digital music player, for example, the user interface 104 can be used to select a particular song or playlist and the screen 102 can visually reflect the actions of the user. The device may also display album art or other images on the screen 102 during playback of the selected song or playlist. The user interface 104 may also be a touch screen and serve as a display in addition to providing the ability to provide input to the device.

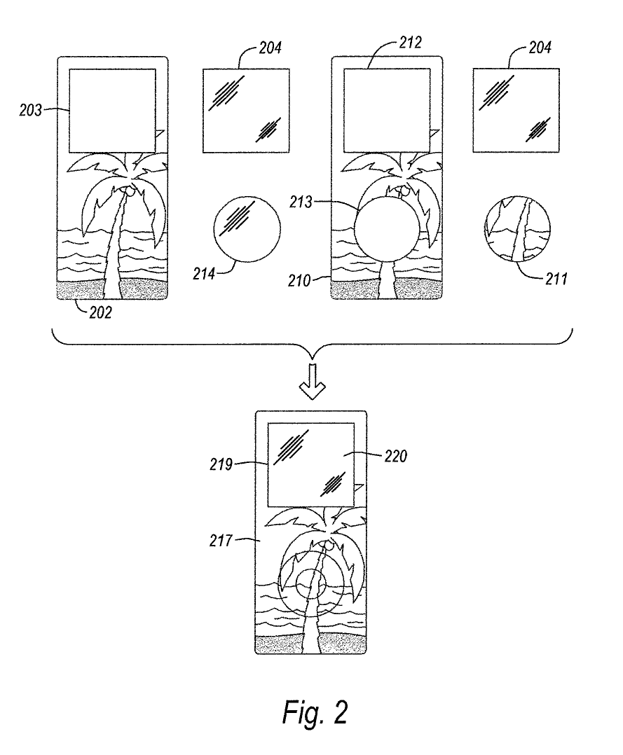

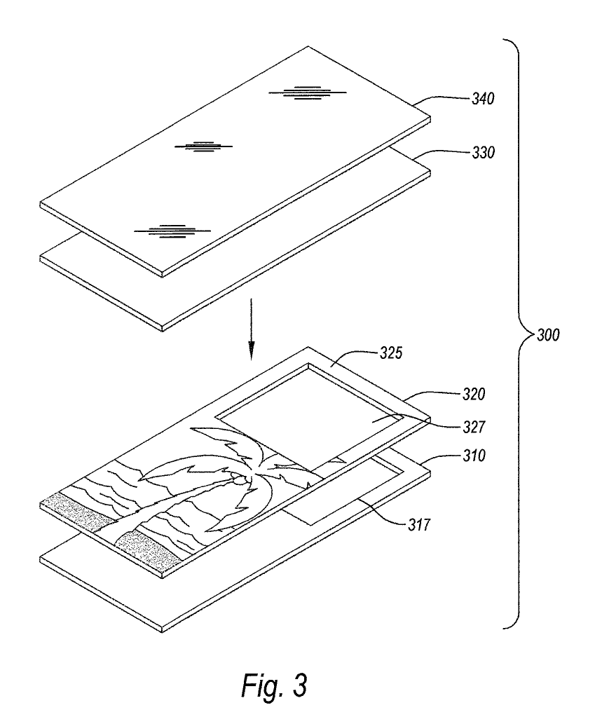

FIG. 2 illustrates various embodiments of a protective cover or of a body cover that includes one or more films for an electronic device such as the device 100 in FIG. 1. The various embodiments of the protective covers illustrated in FIG. 2 includes configurations where at least two separate films are used. As discussed below, however, with reference to FIG. 3, a body cover may include a single film. In one embodiment, a surface of the device is protected by the film 202, which includes an image. Various methods for selecting an image for use in the body cover are described more fully below. As may be understood by one of ordinary skill in the art, the process for forming a body cover for a surface of the device may repeated for the remaining surfaces of the device. Furthermore, as described above, the body cover may be formed so as to cover more than one surface or side of the device. For example, one film may substantially cover a front surface and the remaining sides and surfaces may be substantially covered by a second film, with appropriate cutouts to account for ports, etc.

In the embodiments illustrated in FIG. 2, the films 202 and 210 each include a cutout area 203 and 212, respectively, which accommodate the screen 102 of the device 100. When the film 202 is applied to a device, the user interface is protected by the film 202 and the user is able to customize his or her device by adding an image to their device, despite this customization, however, the cutout area 203 retains the user's ability to interact with the display of the device regardless of the presence of the customized film 202. A separate film 204, in contrast, provides a user with the option of protecting the display such as the screen 102 of the device 100. Thus, a transparent film 204 matching the cutout area 203 can be applied specifically to the screen 102 of the device 100.

In another embodiment, the film 202 and 204 may be a single combined film. IN this case, when the image is generated, the portion of the film corresponding to the display does not receive the image.

Film 212 includes an additional cutout portion 213 which accommodates a user interface 104 of the device 100. In one embodiment of the invention, a film 211 for the user interface 104 of the device 100 also includes an image or a continuation of the image of film 213. One advantage of using this configuration is that it is possible to apply a large amount of image on the device 100 while retaining the user's ability to interact with the user interface 104. In another embodiment, a film 214 corresponding to the user interface 104 may be clear or transparent. In this embodiment, the user interface 104 is protected, and any symbols, decals, or words on the user interface 104 are visible to the user.

The device 206 illustrates the protective cover applied to a device such as illustrated in FIG. 1. Because the screen 209 of the device 206 is flush with the top surface, the film 204 can be applied without creating an air pocket at the boundary 219 between the screen 219 of the device and the front surface 217 of the device 206 where the film 202 or 210 is applied.

As described below, in some cases a single film can be used to cover the front surface 217 and screen 220 of the device 206. Thus, in cases where the screen is slightly inset, a single film can be used to cover the screen and other portions of the surface of the device.

Conversely, if the screen 220 is inset with respect to the top surface 217 of the device more substantially, two or more films may be used, such as in the configuration described in FIG. 2. The first film 204 would be transparent and configured (such as by cutting) to fit the screen 220 while the second film 202 or 210 would include the image and would adhere to the top surface 217 of the device 206. The second film would have a cutout area 203 or 212 for the screen of the device. This enables the film 202 or 210 to lay flat on the device without creating an air pocket at the point where the inset screen 220 and top surface 217 meet. In one embodiment, the cutout area 203 or 212 for a device with an inset screen can be configured to curve down and provide additional protection to the walls of the inset area. This can be achieved, for example, by cutting short slits at each corner such that the film 204 can fold flatly against the surface of the device as the surface slopes down to the inset screen 220. In another embodiment, the film 204 may simply be applied over both the screen 220 and the surface 217. The strength of an adhesive prevents the film 204 from peeling away.

Embodiments of the invention may use additional films to cover the other sides of the device 100. In this description, embodiments of the invention will be described with reference to a film(s) for a single surface of the device 100. Thus, the methods and features described herein with reference to a covering for a single surface of a device may also be used to create films for the additional surfaces of the device.

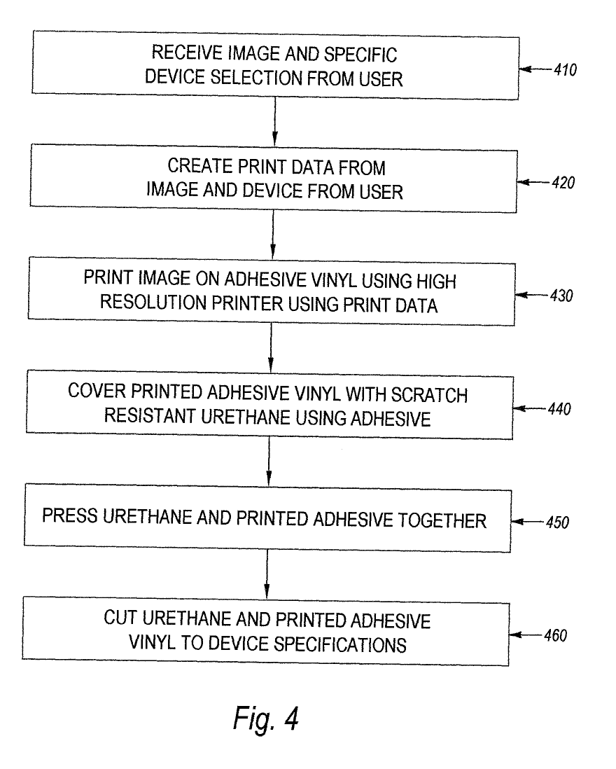

FIG. 3 illustrates a method for creating a film 300 which includes an image. More specifically, FIG. 3 is a schematic view illustrating the construction of a film 300, prior to its application to the device. In this embodiment, a single film 300 may be used to cover the entire front surface of the device 100, including the user interface 104 and the screen 102. As described more fully below with reference to FIG. 4, the method of the invention includes laminating a series of layers together to form a single film 300, which includes a layer 320 on which an image 325 is printed or otherwise formed, and a upper urethane layer 340 or other suitable plastic or material. The film 200 also includes two adhesive layers 310 and 330 in this example. The first adhesive layer 310 is formed on the back surface of the vinyl layer 320 (or other suitable material), opposite to the surface where the image 325 is formed.

In one embodiment of the invention the first adhesive layer 310 and the vinyl layer 320 are formed together prior to the printing process which forms the image 325 on the vinyl layer. More specifically, in a preferred embodiment, the vinyl layer 230 and first adhesive layer 310 may comprise one of various vinyl products which are designed for wraps, such as those that feature air channels in the vinyl or in the first adhesive layer 310 which prevent bubbles and which prevent the first adhesive layer 310 from affixing until pressed or squeegeed down. One advantage of such configurations is that such material allows the film 300 to be lifted and reapplied as needed desired without adhesive properties of the film 300. In the preferred embodiment of the invention, the vinyl layer 320 and first adhesive layer 310 together have a thickness of between 0.10 millimeter and 0.20 millimeters.

In an alternative embodiment, the layer 310 and 320 can be omitted. In this example, the image can be printed on the back surface of the film 340 such that the image is on the urethane (or other plastic) layer 340. This causes the image to be essentially between the layer 340 and the adhesive layer 330. In this example, the printing of the image on the surface of the layer 340 can depend on the surface to which the film is intended. When the surface includes a display, the image may not be printed in the corresponding area. When the surface does not include a display, but may be the back or bottom surface of a device, the printing of the image does not need to account for the display.

An image 325 is printed onto the upper surface of the vinyl layer 320, or on the back surface of the layer 340. When the image is printed on the back surface of the layer 340, it may be reversed. In other words, the image will be primarily viewed through the front surface of the layer 340 or the side that is opposite the side that is printed on. Thus, the image may be manipulated such that it is viewed as intended once printed. For example, the image may be reversed.

In one embodiment of the invention, the printing process is a high resolution, borderless printing process using an 8-color process printer on a white or light colored vinyl layer 320 or on a clear layer 340. The 8-color process printing process may use four diluted or “light” colors in addition to the four dark colors used in most common printing processes. As may be understood by those of skill in the art, one advantage of using an 8-color process is that the image quality is greatly enhanced over the other printing methods currently known in the art. One advantage of using the higher resolution and higher quality printing is that aspects of the invention are able to be used with films 300 which include high resolution images. As described more fully below, because the printing process is able to produce images of high resolution in the films 300, embodiments of the invention are able to create films 300 from personal photographs and the like or other image sources.

Following the printing process where the image 325 is formed on the surface of the vinyl layer 320, a transparent urethane layer 340 is adhered to the upper surface of the vinyl layer 320 using a second adhesive layer 330. The transparent urethane layer 340 may be, by way of example only, a thermoplastic elastomer or a urethane plastic film, which combines the mechanical and physical properties of rubber with the advantages of thermoplasticity. Other examples of the film may include a polyether urethane, a polyester urethane or an aliphatic urethane.

As previously described, the image may be formed or printed on the surface of the layer 340. After printing the image, the adhesive can be applied to the layer 340 such that the image, as previously stated, is between the urethane and the adhesive. In some instances, the ink or other colorant may bond with the layer 340 or may otherwise be incorporated into the layer 340 by heat or pressure or the like. Alternatively, the ink or colorant may simply become permanent once dry. The adhesive may be applied before or after the printed or formed image dries.

In one embodiment, the transparent urethane layer 340 has properties of rubber and of plastic. With these properties, the film has excellent abrasion resistance. Further, application of the film to a scratched surface may hide the scratches or make the scratches less noticeable.

Embodiments of the transparent urethane layer 340 also have a memory than enable the film to be elongated and then return to its original shape. The film can be soft and malleable, yet have high tensile strength. Examples of the transparent urethane layer 340 can have a hardness that ranges from very soft to stiff, by way of example only from Shore 25A-Shore 75D in a durometer range. Further, the transparent urethane layer 340 is designed so as to have good flexibility over a wide durometer range. This hardness or softness of the urethane layer to absorb impact (stretch or deform) and then return to an original shape provides additional protection to a protected device. Thus, embodiments of the invention relate to a multi-layered film that has both abrasion resistance and impact resistance. The urethane layer 340 may have a thickness that is on the order of 8 mills. In another example, the urethane layer 340 may have a thickness that is on the order of 6 mill or on the order of 6-8 mil or greater. This thickness may not include the thickness of the second adhesive layer 330 that is included with the urethane layer 340 in the preferred embodiment of the invention. One of skill in the art can appreciate that thinner or thicker urethane films may be used.

As described above, the properties of the combined urethane layer and vinyl layers make the films of the present invention provide excellent protection as a body cover for a device, while providing the desired level of flexibility and customization.

In some embodiments of the invention, the urethane layer 340 and vinyl layer 320 may not contain plasticizers and are therefore not subject to brittleness. Furthermore, embodiments of the urethane layer 340 and vinyl layer 320 have elastic properties such that the laminated film 300 may stretch or deform when a stress is applied and then return to the original shape when the stress is removed. Thus, the film 300 can be applied or bonded to a device surface using an adhesive, by heat bonding, pressure bonding, and the like or any combination thereof.

In one embodiment of the invention, as described with reference to FIG. 4 and as illustrated in FIG. 2, a single cutting process is performed after the transparent urethane layer 230 is bonded together with the vinyl layer 320 in order to cut the film 300 according to the specifications of the specific device.

In another embodiment of the invention shown in FIG. 3, however, an additional cutting process may be performed after the printing process has occurred so that only the vinyl layer 320 and the adjacent adhesive layer 310 are cut during the first cutting process. In this embodiment, the first cutting process may be performed to remove portions of the film where the image and/or vinyl would interfere with the display or use of the device. When the vinyl layer is not transparent, it is typically cut. Alternatively, the printing process can ensure that the area corresponding to the display, if any, is not printed one. This would potentially omit the need to cut the vinyl layer.

For example, in the configuration shown in FIG. 3, a cutout portion 327 and 317 is removed from the vinyl layer 230 and first adhesive layer 310 in an area corresponding to the screen 102 of a device so that only the transparent urethane layer 340 and transparent adhesive layer 330 are disposed above the screen 102. One advantage of this configuration is that a single film 300 can be used to cover the entire surface of the device, while allowing portions having different transparency to be formed in the film 300 which correspond to the various components of the device.

Regardless of whether a first cutting process is performed solely on the vinyl layer 320 and the adhesive layer 310, the transparent urethane layer 340 is adhered to the upper surface of the vinyl layer 320 using the second adhesive layer 330 to form a film 330 with a preferred thickness which is approximately between 0.26-0.30 millimeters, and more preferably 0.28 millimeters. The thickness of the film 330, however, may be equal to or less than 0.26 millimeters (e.g. 0.15 mm to 0.26 mm) or greater than or equal to 0.30 millimeters (e.g., 0.30 mm to 0.35 mm). Stated another way, the thickness of the film, including the urethane layer and the printed layer and adhesives may be 5-7 mills, 7-10 mills, 8-11 mills, 8-12 mills, 7-13 mills, and the like. Of course, embodiments of the invention contemplate films with thicknesses that may be outside of these ranges.

Thus, embodiments of the invention include systems and methods of creating a body covering which has an image layer disposed therein, wherein the body covering also includes an upper urethane layer which prevents damage to both the image layer and the electronic device.

FIG. 4 illustrates a method for creating a body covering for an electronic device according to an aspect of the invention. The method begins when a request for a covering is received 410 which includes a requested image and specific device selection from the user. As may be understood by one of skill in the art, the specific image used in association with the invention is not limited. The image may be an image selected from a listing of available graphics or, in an alternate embodiment, the invention may provide a mechanism for a user to provide their own image to be incorporated into the film.

Furthermore, this selection may be provided through a variety of interfaces, including a user interface on an online website, or any other submitting and selecting means currently known in the art. In the preferred embodiment, the user is directed to the online interface, where the user may select his or her electronic device from a listing of electronic devices for which the system has cutting and printing templates created. The user may then also select an image or graphic from a list of available options which are owned or licensed by the system. Alternatively, the user may provide their own image to the system by attaching and uploading an image file to the system. This process may also include requiring a statement from the user that the uploaded image file is not subject to any copyright or trademark restrictions. In one embodiment, once the image has been selected or uploaded, the user may be shown a preview of the selected image mapped over their selected device as an indication of what the final body cover would look like when installed on their device. Once the user finalizes their selection, the system may request a payment for the body cover. Once payment has been received and the selection has been finalized, the system would then proceed to step 420.

After the selection has been finalized, the image and device selection information is used 420 to create print data which is then sent to the printer. In one embodiment, the print data corresponds to a mapping of the received image onto a template which corresponds to the specifications of the selected device. This print data may include overspray, which would instruct the printer to print the image beyond the intended cutting lines of the body cover in order to ensure that the image is printed on the entire area of the vinyl layer. Alternatively, the print data may correspond to instructions to perform edgeless or borderless printing, wherein the edge of the printed image corresponds with the intended cutting edge of the film.

Next, the image is printed 430 on the vinyl layer, which is attached to the first adhesive layer, using the high resolution printer. The vinyl layer attached to the first adhesive layer is referred to collectively as the “adhesive vinyl.” As may be understood by one of skill in the art, any number of inks may be used in this process. In the preferred embodiment of the invention, however, the ink is a solvent ink which etches or dissolves into the vinyl layer during the printing process.

Once the image is formed on the vinyl layer, the printed adhesive vinyl is covered 440 with a urethane layer using the second adhesive layer. This process may include removing a backing applied to the second adhesive layer in order to expose the adhesive layer. Once the printed vinyl layer is covered by the urethane layer, the layers are pressed 450 together in order to form a laminated film comprising the urethane and printed adhesive vinyl bonded together via the second adhesive, such that the printed layer disposed therein.

Once the laminated film is bonded together, the film is cut according to the template corresponding to the specifications of the selected device. As described briefly above, this process may include selecting a die-cut template specifically designed for the selected device so that the final body cover covers the entire surface(s) of the device. Hence, as described above the die-cut template may include a number of films, some of which are designed to have the selected image disposed therein, and other films which are designed to be transparent which do not have the selected image layer disposed therein. Alternatively, as described above, a single film may have different portions which include the vinyl and printed image layer, whereas other portions of the film contain only the upper urethane layer.

Thus, when a film is designed for a device either as a body cover or for a specific portion of the device such as the screen, the device is first examined to identify locations that may require attention (such as discontinuities, corners, edges, user interfaces, screens, sloping surfaces, rounded edges or corners, etc.). Further, the film can be designed with various options in mind. For example, portions of the device that correspond to cut out areas in a film can be provided with a separate film if desired. Often, the form factor for the film for a particular device is determined prior to receiving an image and device identification from a user.

In some instances, the user may be provided with a preview of how the film will look once finished. The user may then have the option of changing the image, purchasing the film, and the like.

For a body cover for a given device, at least two films may be needed, although a single film may be provided as a body cover for some devices. Typically, one film is prepared for a top or front surface of the device and a second film is prepared for the bottom or back surface of the device and any number of additional films may be required for the various cutout portions of the device. One of the first or second film may also be configured to protect sides of the device. The specific configuration of the films may depend on the shape of the device. For example, often the top film and/or the bottom film will wrap around the sides of the device such that coverage or protection is provided to the sides of the device. Alternatively, separate films could be prepared for the sides. In addition, the corners or edges of the two films are cut or shaped to account for corners, sloping surfaces, etc., and to insure that the films lay flat against these types of surfaces of the device when applied to the device.

During the cutting process, appropriate cuts are made in the films which depend on the specific configuration of the die-cut which corresponds to the selected device. This may include, for example, a cutout area for the user interface. Note that the film that is cut out can optionally be applied separately as a film for the user interface or other aspect of the device. For example, in FIG. 2, for example, the user interface can be covered with a film which includes the image, a transparent film, or not covered with a film at all.

In one embodiment of the invention, the system may be configured so as to form a number of body coverings in a single aggregate printing and cutting process. In this configuration, the system may aggregate all the print data for a number of user requests together in order to reduce the manufacturing time and expense required when only a single body cover is formed. This process may include sending the print data through an additional optimization process in order to determine how to maximize the amount of body covers which may be produced during the manufacturing process. As such, a large vinyl sheet may be printed with a number of different images during the printing process for each of the different film(s) in a single body cover request in addition to those for the body cover requests of other users. In order to ensure proper alignment when larger printing jobs are performed, the printing process may also include printing alignment data on the vinyl sheet which may be used in the cutting process in order to ensure proper alignment between the various steps of the manufacturing process.

Once the body cover is formed, the body cover is packaged together and sent to the user as requested. In one embodiment, the body cover may be part of a kit which is sent to a user. The method of FIG. 4 can be adapted as described herein when the film does not include a vinyl layer or when the image is printed on a urethane layer of the film. IN this case, after receiving an image and device selection and after creating the print data, the image is printed on the urethane layer. An adhesive layer is then deposited on top of the image. The film is then cut according to the device specifications.

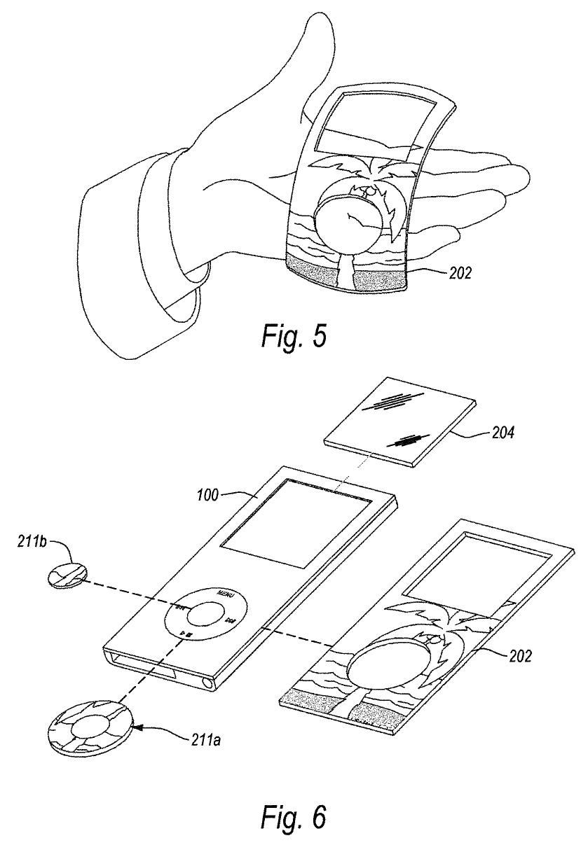

FIG. 5 illustrates a film 202 held in a user's hand. The film 202 is flexible or malleable. The film 202 (as well as other films discussed herein), for example, may have elongation properties of greater than 400% and tensile strengths on the order of 9200-9600 psi. Embodiments of the invention are not limited to these properties, however, and includes films with different properties or with different ranges of the same properties. In addition to elongation and tensile strength, the hardness of the film can vary as described previously. Also, the tensile strength and elongation of the film 202 may depend on the thickness of the film 202.

FIG. 6 illustrates another embodiment of a body cover which illustrates the various films 204, 202, 211a and 211b which may be used together in order to cover the front surface of a device 100. This example illustrates the flexibility of the film in accordance with embodiments of the invention. In this example, the films 202, 204, 211a and 211b are each applied to the device 100 in order to entirely cover the front surface of the device with the customized cover. Similar films may be used to cover additional surfaces of the device, or the films may be designed so as to cover more than one surface of the device, or even to wrap entirely around the device.

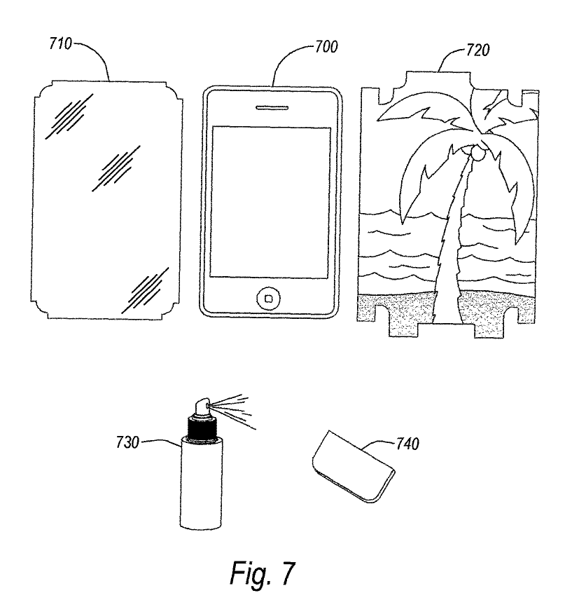

FIG. 7 illustrates a kit which may contain the body cover for another exemplary device. In this embodiment, the device has a screen or display which also acts as a user interface. The interface may be a touch screen device such that the display serves to both display information to a user and receive input from the user. The combined screen and user interface covers substantially the entire front surface of the device 700. As such, a first film 710 for this device comprises a transparent cover, which corresponds to a film which is entirely comprised of the transparent urethane layer 340 and the second adhesive layer 330 without the printed vinyl layer 320 and first adhesive layer 310. Thus, the front surface of the device 700 is protected by a transparent urethane layer, which protects the front surface of the device 700 including the combined display and user interface element, without interfering with the user's ability to interact with these elements. In this example, the customized layer of vinyl is not included.

In this embodiment, the kit also includes a second film 720, which is designed to cover both the back surface of the device 700, in addition to the sides of the device, with cutout portions which correspond to the various ports and controls of the device 700. In this configuration, the second film 720 has an image 325 printed on a vinyl layer 320 formed therein. Thus, while the specific configuration of the device 700 makes it undesirable to integrate a customized image layer into the front surface of the device 700 (because the customized image may interfere with a view of the display), aspects of the invention may also be used to create customized body covers for remaining surfaces of the device.

In another example, the film 720 may have a urethane layer with an image printed thereon and an adhesive layer. In this example, the vinyl layer is not included because the image is formed directly on the urethane layer of the film 720. The film 710 may be similarly formed. For example, the film 202 in FIG. 5 may be a film with no cutouts and may only include a urethane (or other plastic) layer and an adhesive with an image printed on the surface adjacent to the image. Thus, the adhesive is applied on the same side of the urethane layer as the image. Thus, the image is effectively between the urethane layer and the adhesive. In this case, a cutout may for the display may not be required as the printing process may be controlled such that the image is not printed in the area of the film corresponding to the display. In some instances, and to account for potential overspray of ink, the unprinted area may be larger than the display of the device to ensure that the printed image does not interfere with the display. This can prevent the need to have a cut in the film.

In some instances, particularly those instances which include films which comprise solely the transparent urethane layer, the kit may also include a solution that may be used during application of the body covering to a device. The solution is designed to improve the ease with which the body covering is applied as well as improve the adhesion of the body covering to the device. The solution may be applied to the film prior to application. The solution may provide additional time for the user to properly position the film before the adhesive fully sticks to the device. The solution also enables trapped air bubbles to be removed as the film adheres to the surface of the device. The solution may be, by way of example only, a mixture of soap and water. Alternatively, the solution may comprise an alcohol, which may be used to clean the surface of the device 700 prior to the application process. In effect, the solution may clean the surface of the device 700 and/or delay the adhesion of the film to the device and improve customer satisfaction by providing a user with more time to properly position each film of a body cover on a device. The inks in the image are protected by the adhesive layer when the image is printed on the urethane layer and as a result, the solution does not degrade the quality of the image.

In one example, the film 720 may be applied to the device first because the solution 730 may not be needed. For example, the adhesive on the vinyl layer is often different and has a different configuration from the adhesive of the urethane layer. The adhesive of the film 720 that adheres to the surface of the derive 700, as previously described, may have ridges or other structure. After the film 720 is adhered to the device, the solution may be used in adhering the film 710 to the display surface of the device 700. As previously stated, the form factor of the film 10 may cover only the top surface of the device 700, a portion of the top surface, and/or a portion of the sides of the device 700 in addition to the top surface. The film 710, by way of example only, may have holes formed therein to accommodate the speaker and button on the top surface of the device 700. as previously discussed.

The kit may also include a squeegee 740 or other application means, which assist in applying the films 710 and 720 to the device 700. More specifically, the squeegee 740 may be used to ensure that any bubbles which may have formed between the films 710 and 720 and the surface of the device 700 during the installation process may be removed. In some embodiments, the squeegee 740 may not be needed to apply the film 720 because the adhesive may be shaped to accommodate air bubbles. Alternatively, the bubbles may not be visible.

In conclusion, aspects of the invention provide a customizable body cover for an electronic device, wherein the body cover include an image printed on a vinyl layer in addition to a transparent urethane layer which protects the device and the image from being scratched or damaged. This enables users to customize their devices with various images, while ensuring that the images are protected from damage. Furthermore, the embodiments described herein provide body covers or films that are both durable and reusable, so that the body covers may be removed and reapplied as needed or desired.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A body cover for an electronic device, the covering comprising:
a transparent urethane layer;
an adhesive layer;
an image formed on a first side transparent urethane layer, wherein the image is between the transparent urethane layer and the adhesive layer, wherein the image is visible through a second side of the transparent urethane layer;
wherein the urethane layer is configured to provide a protective covering for the surface of the electronic device and the image formed the.

2. The body cover of claim 1, further comprising one or more cutout areas, at least one cutout area sized to accommodate a user interface of the electronic device.

3. The body cover of claim 1, wherein the body cover is customizable such that the image is selected by a user before the body cover is manufactured.

4. The body cover of claim 1, further comprising cut out areas such that one or more ports of the device remain accessible to a user.

5. The body cover of claim 2, wherein the body cover further comprises a second film comprising a urethane material which is sized to accommodate the user interface and which is configured to be adhered directly to the user interface.

6. The body cover of claim 1, wherein the image is not printed on a portion of the urethane layer that corresponds to a display of a device.

7. The body cover of claim 1, the transparent urethane layer having a thickness of between 5 to 7 mills.

8. The body cover of claim 1, wherein the image is printed on the urethane layer using an 8-color printing process.

9. The body cover of claim 1, wherein the transparent urethane layer comprises at least one of:
a urethane;
a thermoplastic elastomer;
a polyether urethane;
a polyester urethane or
an aliphatic urethane.

10. The body cover of claim 1, wherein the body cover is capable of being removed and reapplied to the electronic device.

11. A method for forming a body covering for an electronic device, the method comprising:
forming an image on a first surface of a plastic layer, wherein the image is visible through a second surface of the plastic layer after applied to the electronic device;
forming an adhesive layer on the plastic layer such that the image is between the plastic layer and the adhesive layer, wherein the plastic layer and the adhesive layer form a film with an image formed therein; and
cutting the film to form a body covering such that the body covering corresponds with the surface of the electronic device.

12. The method of claim 11, wherein cutting the film to form a body covering comprises cutting cut out areas such that one or more ports, displays, or user interfaces of the device remain accessible to a user.

13. The method of claim 12, further comprising forming a second film from a plastic material which is sized to accommodate and be affixed to at least one of the one or more ports, displays, or user interfaces.

14. The method of claim 11, wherein the plastic comprises one of:
of urethane;
a thermoplastic elastomer;
a polyether urethane;
a polyester urethane or
an aliphatic urethane.

15. A kit for applying a covering to an electronic device, the kit comprising:
a covering including at least one film, the covering being capable of being covering a surface of the electronic device, the at least one film including:
a first film including a transparent urethane layer and an adhesive layer formed on a first side of the transparent urethane layer, wherein an image is formed on the first side such that the image is between the transparent urethane layer and the adhesive layer; wherein the urethane layer provides a protective covering for the surface of the electronic device and the image formed on the vinyl layer;
a second film including a transparent urethane layer and an adhesive layer, the second film configured to be adhered to at least a display of the electronic device; and
means for applying the covering to a surface of the device.

16. The kit for applying a covering to an electronic device according to claim 15, further comprising a liquid for moistening a surface of the electronic device before the first and second films are applied.

17. The kit for applying a covering to an electronic device according to claim 15, wherein the first film further includes cut out areas such that one or more ports, displays, or user interfaces of the electronic device remain accessible to a user after the covering is applied.

18. The kit for applying a covering to an electronic device according to claim 15, wherein at least the first film of the covering is capable of being removed and reapplied to the electronic device a plurality of times.
